(19) United States
(12) Patent Application Publication
(10) Pub. No.: US 2017/0344355 A1
(43) Pub. Date: Nov. 30, 2017

(54) UPDATING VEHICLE SYSTEM MODULES

(71) Applicant: GM Global Technology Operations LLC, Detroit, MI (US)

(72) Inventors: Susanta P. SARKAR, Rochester Hills, MI (US); Dana B. FECHER, Farmington Hills, MI (US); Jessica L. BOZYMOWSKI, Rochester Hills, MI (US); Jeffrey J. OLSEN, Royal Oak, MI (US); James D. FORSMARK, St. Clair Shores, MI (US)

(21) Appl. No.: 15/167,603

(22) Filed: May 27, 2016

(51) Int. Cl. G06F 9/445; H04W 4/00

(52) U.S. Cl. CPC G06F 8/65; H04W 4/001

(57) ABSTRACT

A system and method for providing an update to vehicle system modules, wherein the method includes generating a parts manifest identifying soft parts associated with an update for the vehicle system modules, the parts manifest including one or more download link(s) relating to the soft parts in the parts manifest, and wherein the one or more download link(s) provide a location from which content associated with each of the soft parts is downloaded to a vehicle and thereafter assembled by the vehicle into an update package, transmitting the parts manifest to the vehicle, and receiving an indication from the vehicle confirming installation of the update package to the vehicle system modules.

### TECHNICAL FIELD

The present invention generally relates to vehicle systems and, more particularly, to systems and methods for updating vehicle system modules.

### BACKGROUND

In recent years, advances in technology have led to substantial changes in the design of automotive vehicles. Modern vehicles include an increasing number of electronic components and embedded systems, collectively, vehicle system modules, for controlling one or more of the electrical systems or subsystems of the vehicle. The most common include, for example, engine control units, traction control systems, power steering systems, braking systems, climate control systems, navigation systems, and infotainment systems. Additionally, modern vehicles are often capable of supporting communications to and from external components, for example, via external communications networks (e.g., cellular networks, wireless networks, personal area networks, or the like) or a physical interface (e.g., a bus interface or the like). During the lifetime of a vehicle, it's often necessary to reprogram or update one or more of the vehicle electronic components, to support or to provide new features and functionality, or to resolve potential issues with existing features and/or functionality.

An emerging technique for providing updates to vehicle system modules includes the use of over-the-air programming through one or more vehicle systems having access to external cellular and/or wireless networks. Currently, over-the-air updates to vehicle system modules are pre-assembled and formed as a package, which may include only vehicle-specific content, or may include content relating to thousands of different software and/or firmware configurations. The assembled packages are stored on a server and downloaded to the vehicle as a complete package. Creating, storing, and managing these content-inclusive packages at multiple locations requires large capacity servers and increases the complexity associated with cloud-based services. The problem is compounded by different option content present in the same vehicle model, requiring many unique packages, for slight variations, even though packages include largely common components. In addition, downloading large files from the cloud servers to the vehicle through cellular networks is time intensive, costly, and increases risk of potential transmission failures.

### SUMMARY

According to an embodiment of the invention, there is provided a method for providing an update to vehicle system modules. The method includes generating a parts manifest identifying soft parts associated with an update for the vehicle system modules, the parts manifest including one or more download link(s) relating to the soft parts in the parts manifest, and wherein the one or more download link(s) provide a location from which content associated with each of the soft parts is downloaded to a vehicle and thereafter assembled by the vehicle into an update package, transmitting the parts manifest to the vehicle, and receiving an indication from the vehicle confirming installation of the update package to the vehicle system modules.

According to another embodiment of the invention, there is provided a method for providing an update to vehicle system modules. The method includes receiving a parts manifest identifying soft parts associated with an update for the vehicle system modules, the parts manifest including one or more download link(s) associated with each of the soft parts in the parts manifest, retrieving content associated with each of the soft parts using a location of the content provided by the one or more download link(s), assembling the content for each of the soft parts into an update package, and providing the update package to the vehicle system modules.

According to another embodiment of the invention, there is provided a system for providing an update to vehicle system modules. The system includes a server communicatively coupled to a vehicle communication system, wherein the server is configured to generate a parts manifest identifying soft parts associated with an update for the vehicle system modules, the parts manifest including one or more download link(s) relating to the soft parts in the parts manifest, and wherein the one or more download link(s) provide a location from which content associated with each of the soft parts is downloaded to a vehicle and thereafter assembled by the vehicle into an update package, transmit the parts manifest to the vehicle, and receive an indication from the vehicle confirming installation of the update package to the vehicle system modules.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a block diagram depicting a particular embodiment of a communications system according to FIG. 1 that is capable of utilizing the method disclosed herein; and

FIG. 3 is flow chart depicting an embodiment of a method for updating vehicle system modules according to the exemplary system illustrated in FIGS. 1 and 2.

### DETAILED DESCRIPTION OF THE ILLUSTRATED EMBODIMENTS

The system and method disclosed herein relate to providing updates to vehicle system modules having software and hardware components configured to operate, control, or monitor one or more vehicle systems. The updates may be necessitated by mandatory or voluntary recalls relating to the functionality of the vehicle system modules, or they may be directed to improving and/or replacing features and applications on the system modules. The updates may include only delta instructions, which replace only the portion of the software and/or firmware that has changed, or may include instructions that replace the existing software and/or firmware in its entirety.

Traditionally, the updates are delivered over-the-air to the vehicle as a package, wherein a remote server acquires the software and/or firmware components (referred to as soft parts) and assembles the components into an update package. The entire contents of the update package are subsequently transmitted to a content delivery network and stored until the complete package is sent over-the-air to the vehicle. Disclosed below is a system and method for providing over-the-air updates to vehicle system modules without the step of pre-assembling the components into a unitary package, thus eliminating the need to store and transmit large content files to the vehicle.

In one embodiment, the disclosed system and method determines an existing state of the software and/or firmware relating to one or more of the vehicle system modules, and determines if any of the current software and/or firmware requires updating. A parts manifest identifying the components needed to bring the current software and/or firmware on the vehicle system modules up-to-date is generated by a remote server, which in one embodiment is part of a remote facility that provides back-end functions to the vehicle. The parts manifest includes download links, generally in the form of a uniform resource locator (URL), for each of the soft parts required to update the vehicle system modules. The collective content associated with the group of download links constitutes all of the components (i.e., parts) necessary to assemble the update package. The remote server transmits the parts manifest containing the download links to the vehicle. An update module in the vehicle, configured to manage and execute the software and/or firmware updates to the vehicle system modules, receives the manifest and, using the download links, retrieves the content of the individual parts of the update package. The update module then assembles the downloaded content files of the update package for delivery to the vehicle system modules. Therefore, the server provided by the disclosed system and method is required only to store unique components.

### Communications System—

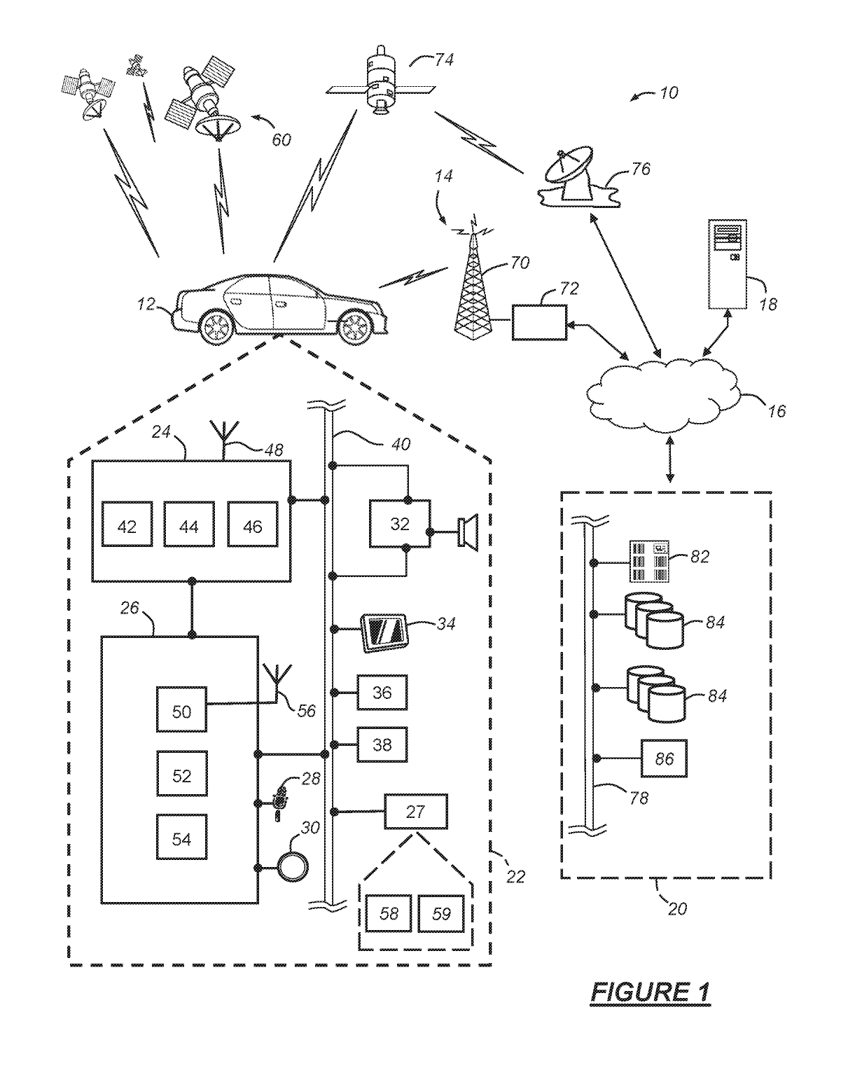

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a remote facility 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 22 is shown generally in FIG. 1 and includes a telematics unit 24, an infotainment unit 26, a central gateway module 27, a microphone 28, one or more pushbuttons or other control inputs 30, an audio system 32, a visual display 34, and a GPS module 36 as well as a number of other vehicle system modules (VSMs) 38. Some of these devices can be connected directly to the telematics unit 24 and/or infotainment unit 26 such as, for example, the microphone 28 and pushbutton(s) 30, whereas others are indirectly connected using one or more network connections, such as a communications bus 40. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 24 is itself a vehicle system module (VSM) and can be implemented as an OEM-installed (embedded) or aftermarket device that is installed in the vehicle and that enables wireless voice and/or data communication over wireless carrier system 14 and via wireless networking. This enables the vehicle to communicate with remote facility 20, other telematics-enabled vehicles, or some other entity or device. The telematics unit 24 preferably uses radio transmissions to establish a communications channel (a voice channel and/or a data channel) with wireless carrier system 14 so that voice and/or data transmissions can be sent and received over the channel. By providing both voice and data communication, telematics unit 24 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the remote facility 20) and data communication (e.g., to provide GPS location data or vehicle diagnostic data to the remote facility 20), the system can utilize a single call over a voice channel and switch as needed between voice and data transmission over the voice channel, and this can be done using techniques known to those skilled in the art.

According to one embodiment, telematics unit 24 utilizes cellular communication according to either GSM, UMTS, CDMA, 4G LTE, or 5G standards and beyond. Thus, telematics unit 24 includes a standard cellular chipset 42 for voice communications like hands-free calling, a wireless modem for data transmission, an electronic processing device 44, one or more digital memory devices 46, and a dual antenna 48. It should be appreciated that the modem can either be implemented through software that is stored in the telematics unit and is executed by processor 44, or it can be a separate hardware component located internal or external to telematics unit 24. The modem can operate using any number of different standards or protocols such as 4G LTE, UMTS, EVDO, CDMA, GPRS, and EDGE.

Wireless networking between the vehicle and other networked devices can also be carried out using telematics unit 24. For this purpose, telematics unit 24 can be configured to communicate wirelessly according to one or more wireless protocols, including short range wireless communication (SRWC) such as any of the IEEE 802.11 protocols, WiMAX, ZigBee™, Wi-Fi direct, Bluetooth™, or near field communication (NFC). When used for packet-switched data communication such as TCP/IP, the telematics unit can be configured with a static IP address or can be set up to automatically receive an assigned IP address from another device on the network such as a router or from a network address server.

Processor 44 can be any type of device capable of processing electronic instructions including microprocessors, microcontrollers, host processors, controllers, vehicle communication processors, and application specific integrated circuits (ASICs). It can be a dedicated processor used only for telematics unit 24 or can be shared with other vehicle systems. Processor 44 executes various types of digitally-stored instructions, such as software or firmware programs stored in memory 46, which enable the telematics unit to provide a wide variety of services. For instance, processor 44 can execute programs or process data to carry out at least a part of the method discussed herein.

Telematics unit 24 can be used to provide a diverse range of vehicle services that involve wireless communication to and/or from the vehicle. Such services include: turn-by-turn directions and other map-based navigation-related services that are provided in conjunction with the GPS-based vehicle navigation module 36; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by the infotainment unit 26 and is stored for current or later playback. The above-listed services are by no means an exhaustive list of all of the capabilities of telematics unit 24, but are simply an enumeration of some of the services that the telematics unit is capable of offering. Furthermore, it should be understood that at least some of the aforementioned modules could be implemented in the form of software instructions saved internal or external to telematics unit 24, they could be hardware components located internal or external to telematics unit 24, or they could be integrated and/or shared with each other or with other systems located throughout the vehicle, to cite but a few possibilities. In the event that the modules are implemented as VSMs 38 located external to telematics unit 24, they could utilize vehicle bus 40 to exchange data and commands with the telematics unit.

Infotainment unit 26 is included as part of vehicle electronics 22 and is also a VSM that can be an OEM-installed (embedded) or aftermarket device that is installed in the vehicle. Infotainment unit 26 may control and/or provide numerous functions for the vehicle and is shown to include wireless access point (WAP) 50, processor 52, and memory 54. Infotainment unit 26 may be connected to a bus 40 and may control numerous vehicle modules and/or components, such as audio system 32, visual display 34, GPS 36, and/or other VSMs 38. Additionally, infotainment unit 26 may be directly connected to one or more devices or components, such as, for example, microphone 28, button 30, and telematics unit 24, as shown. Infotainment unit 26 may also receive information or data from any of the components of the vehicle to which it may be communicatively connected to, including non-vehicle electronics that it may connect to, such as via WAP 50. The infotainment unit 26 is shown to include a processor 52 and memory 54, which allow the unit to process and store information or data. Processor 52 can be any type of device capable of processing electronic instructions and, for examples, see the description above with respect to processor 44 of telematics unit 24. Similarly, memory 54 is analogous to memory 46 included in telematics unit 24 and may be used to store data received, generated, or otherwise obtained by infotainment unit 26, such as via WAP 50.

Vehicle wireless access point (WAP) 50 is shown to be included in infotainment unit 26; however, WAP 50 may be incorporated into a different module, such as telematics unit 24, or may be a stand-alone module. As used herein a “wireless access point” (abbreviated “WAP”) is a hardware and software device that communicates using short range wireless communication (SRWC) with client devices to provide the client devices with data access to local or remote network(s) via a wired and/or wireless connection from the WAP to a public or private network such as the Internet. The vehicle WAP 50 may be coupled to a router or other network access device, such as telematics unit 24, which will allow it to connect to remote network(s) (e.g., computer 18 via cellular carrier system 14 and land network 16) thereby providing remote network access to one or more client devices to which it connects. As shown, WAP 50 may include an antenna 56 to improve its reception and/or transmission of wireless signals and, in other embodiments, may include multiple antennas depending on, for example, the specific wireless protocol used (e.g., IEEE 802.11n). Additionally, WAP 50 may include a dual band transceiver that allows it to communicate on multiple wireless channels, such as the 2.4 GHz and 5 GHz frequency bands used by IEEE 802.11 (e.g., 802.11b/g/n and 802.11a/h/j/n/ac).

Centralized gateway module (CGM) 27 is an ECU that serves as a router for central diagnostics and, in at least one embodiment, receives and executes software and/or firmware updates for all other VSMs 38. In some embodiments, CGM 27 may also be referred to as an update module. CGM 27 is preferably connected by communications bus 40 to the other VSMs, as well as to the telematics unit 24 and infotainment unit 26. In some embodiments, CGM 27 may be configured as understood in the art to have direct access to external cellular and/or wireless network access, or may be configured to have indirect access to such networks through telematics unit 24 and/or infotainment unit 26. As will be explained in greater detail below, updates may reconfigure VSM (or ECU) firmware, software, or the like (e.g., and in at least one implementation, the updates are reflash updates).

The CGM 27 includes a processor 58 and memory 59. Processor 58 can be any type of device capable of processing electronic instructions including microprocessors, microcontrollers, host processors, controllers, vehicle communication processors, and application specific integrated circuits (ASICs). Processor 58 executes various types of digitally-stored instructions, such as software or firmware programs stored in memory 59, which enable the processor 58 to execute programs or process data to carry out at least a part of the method discussed herein. The memory 59 may include non-transitory computer usable or readable medium, which include one or more storage devices or articles. Exemplary non-transitory computer usable storage devices include conventional computer system RAM (random access memory), ROM (read only memory), EPROM (erasable, programmable ROM), EEPROM (electrically erasable, programmable ROM), and magnetic or optical disks or tapes.

In at least one embodiment, the CGM 27 is configured to receive data files containing download links from the remote facility 20, either directly or indirectly via a cellular link and/or via a vehicle wireless access point. As explained in detail below, the download links are generally in the form of a uniform resource locator (URL) and are transmitted to the CGM 27 as part of a soft parts manifest that identifies the components (e.g., soft parts) needed to bring the current software and/or firmware on the vehicle system modules up-to-date. The CGM 27 is configured to retrieve the content files associated with each of the soft parts identified in the manifest using the download links. As understood by those skilled in the art, a URL is a standardized naming convention for addressing data (e.g., files, documents, etc.) accessible over the Internet. Stated differently, a URL is a reference to a resource that specifies its location on a computer network and a mechanism for retrieving it. In one embodiment of the disclosed system, the download links provided in the manifest contain unique files and refer to a location of a content delivery node that stores the content associated with the soft part update files. In some embodiments, the files and/or content associated with each of the soft parts identified in the manifest may be independently executable, while in other embodiments, some or all of the files and/or content associated with each of the soft parts identified in the manifest may not be independently executable, but are subsequently assembled as described below into an update package executable by the CGM 27 and/or the VSMs.

The CGM 27 is further configured to assemble the downloaded content into an update package that can be thereafter disseminated to the target VSMs. The update package may contain, for example, one or more software and/or firmware updates relating to one or more VSMs and information including installation instructions, which may include specific configurations relating to a vehicle type and/or features, and/or VSM settings. For example, in one embodiment, the CGM 27 may receive a set of instructions (e.g., code, script, or the like) that are capable of being read and executed by the VSMs 38 to modify one or more operation(s) associated therewith. For example, the existing code or instructions relating to firmware and/or software residing in the VSMs may be modified (e.g., by adding or incorporating new code or instructions, deleting or overwriting at least a portion of the existing code or instructions, and the like) and/or the parameters, settings and/or other configuration information referenced by the code or instructions of the VSMs may be modified (e.g., changing or overwriting existing configuration information, adding or incorporating new configuration information referenced by existing and/or new code or instructions, and the like). Modifying the underlying code and/or configuration information upon which a VSM 38 is based on influences the subsequent operation thereof.

Referring once again to FIG. 1, GPS module 36 receives radio signals from a constellation 60 of GPS satellites. From these signals, the module 36 can determine vehicle position that is used for providing navigation and other position-related services to the vehicle driver. Navigation information can be presented on the display 34 (or other display within the vehicle) or can be presented verbally such as is done when supplying turn-by-turn navigation. The navigation services can be provided using a dedicated in-vehicle navigation module (which can be part of GPS module 36), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to remote facility 20 or other remote computer system, such as computer 18, for other purposes, such as fleet management. Also, new or updated map data can be downloaded to the GPS module 36 from the remote facility 20 via the telematics unit 24.

Vehicle electronics 22 also includes a number of vehicle user interfaces that provide vehicle occupants with a means of providing and/or receiving information, including microphone(s) 28, pushbutton(s) 30, audio system 32, and visual display 34. As used herein, the term “vehicle user interface” broadly includes any suitable form of electronic device, including both hardware and software components, which is located on the vehicle and enables a vehicle user to communicate with or through a component of the vehicle. Microphone 28 may provide audio input to the infotainment unit 26 to enable the driver or other occupant to provide voice commands and carry out hands-free calling via the wireless carrier system 14. For this purpose, it can be connected to an on-board automated voice processing unit utilizing human-machine interface (HMI) technology known in the art. One or more pushbutton(s) 30 can allow manual user input into the infotainment unit 26 to initiate wireless telephone calls and provide other data, response, or control input. Separate pushbuttons can be used for initiating emergency calls versus regular service assistance calls to the remote facility 20. Audio system 32 provides audio output to a vehicle occupant and can be a dedicated, stand-alone system or part of the primary vehicle audio system. Visual display 34, such as a touch screen on the instrument panel or a heads-up display reflected off of the windshield, can be used to provide a multitude of input and output functions. Various other vehicle user interfaces can also be utilized, as the interfaces of FIG. 1 are only an example of one particular implementation.

Apart from the telematics unit 24, infotainment unit 26, audio system 32, and GPS module 36, the vehicle 12 can include other vehicle system modules (VSMs) 38 in the form of electronic hardware components that are located throughout the vehicle and typically receive input from one or more sensors and use the sensed input to perform diagnostic, monitoring, control, reporting and/or other functions. Each of the VSMs 38 is preferably connected by communications bus 40 to the other VSMs, as well as to the telematics unit 24 and infotainment unit 26, and can be programmed to run vehicle system and subsystem diagnostic tests. Non-limiting examples of VSMs include an engine control module (ECM) that controls various aspects of engine operation such as fuel ignition and ignition timing, a powertrain control module that can regulate operation of one or more components of the vehicle powertrain, and a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16 or the Internet. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as 4G LTE. The wireless carrier system 14 can include a Policy Change Rule Function (PCRF), an Online Charging System (OCS), or both that can identify communications carried out using licensed communications frequency bands and then charges accounts associated with the vehicle telematics unit 30 based on that usage. As will be appreciated by those skilled in the art, various cell tower/base station/MSC arrangements are possible and could be used with wireless system 14. For instance, the base station and cell tower could be co-located at the same site or they could be remotely located from one another, each base station could be mounted on a single cell tower or a single cell tower could service various base stations, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 74 and an uplink transmitting station 76. Uni-directional communication can be, for example, satellite radio services, wherein programming content (news, music, etc.) is received by transmitting station 76, packaged for upload, and then sent to the satellite 74, which broadcasts the programming to subscribers. Bi-directional communication can be, for example, satellite telephony services using satellite 74 to relay telephone communications between the vehicle 12 and station 76. If used, this satellite telephony can be utilized either in addition to or in lieu of wireless carrier system 14.

Land network 16 may be a conventional land-based telecommunications network that is connected to one or more landline telephones and connects wireless carrier system 14 to remote facility 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, remote facility 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 24 and wireless carrier 14. Other such accessible computers 18 can be, for example: a service center computer where diagnostic information and other vehicle data can be uploaded from the vehicle via the telematics unit 24; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or remote facility 20, or both. A computer 18 can also be used for providing Internet connectivity such as DNS services or as a network address server that uses DHCP or other suitable protocol to assign an IP address to the vehicle 12.

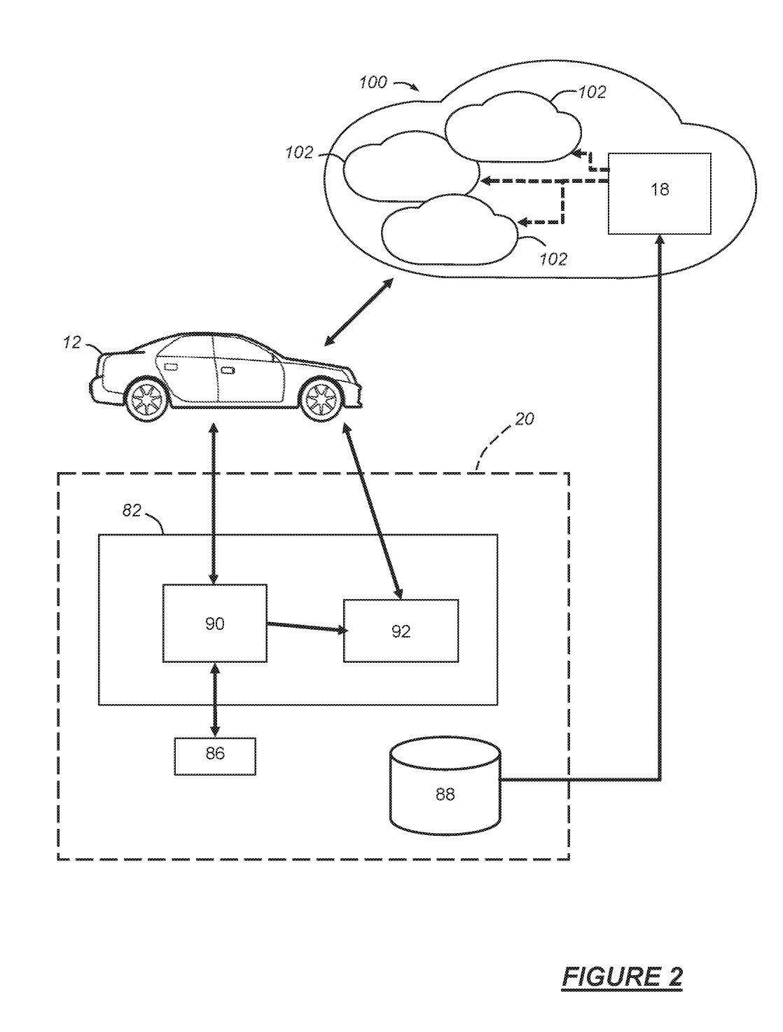

With further reference to the architecture of FIG. 1, and referring more specifically to FIG. 2, in one embodiment, computer 18 may represent a content delivery server that functions as a centralized repository for the data associated with the software and/or firmware for the update packages. The content delivery server 18 is part of a content delivery network 100, which in one embodiment is a cloud-based network that serves as a distribution platform for all of the update package content. The content delivery network 100 can be configured to manage the various versions of the update packages and facilitates the delivery (i.e., download) of the package contents to the vehicles through a plurality of content delivery nodes 102. One of ordinary skill in the art understands that the server architecture and related cloud services shown in FIG. 2 are exemplary and that other configurations and combinations of services are possible and within the scope of this disclosure.

Remote facility 20 is designed to provide the vehicle electronics 22 with a number of different system back-end functions. The remote facility 20 may include one or more switches, servers, databases, live advisors, as well as an automated voice response system (VRS), all of which are known in the art. Remote facility 20 may include any or all of these various components and, preferably, each of the various components are coupled to one another via a wired or wireless local area network 78. With reference to FIGS. 1 and 2, in one embodiment, the remote facility 20 further includes a server 82, a database 84, a soft parts management module 86, and a soft parts repository 88. While each of the components set forth above are presented individually, one of ordinary skill in the art understands that this presentation is merely exemplary and that the components can be combined and implemented in different configurations consistent with the scope of the method described herein. Moreover, while each of components set forth above are referenced as part of the remote facility 20, the components are not physically restricted to one another or to a particular physical location.

Server 82 generally represents a computing system or another combination of processing logic, circuitry, hardware, and/or other components that are coupled to wireless carrier system 14 and/or land network 16. In one embodiment, server 82 may be an over-the-air (OTA) server capable of communicating with the vehicle 12 and supporting the processes, tasks, operations, and/or functions relating to the method described herein. In addition, data transmissions may be passed via a modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. As shown in the embodiment illustrated in FIG. 2, the OTA server 82 includes a device management (DM) server 90 and a download (DL) server 92.

DM server 90 is communicatively coupled to, and serves as an interface between, soft parts management module 86 and vehicle 12, and in one particular embodiment, either directly or indirectly to CGM 27. DM server 90 may include a processing system and a data storage element (or memory) capable of storing programming instructions, that, when read and executed by the processing system, cause DM server 90 to perform operations relating to managing and facilitating the software and/or firmware updates to the VSMs 38. In one implementation, DM server 90 is configured to query the vehicle 12 for an “AS IS” state of the VSMs 38 to determine a current configuration of the VSMs 38. As used herein, configuration of the VSMs 38 refers broadly to a specific set and/or arrangement of internal and/or external components of the VSM including hardware, software, firmware, and other VSM related settings. The configuration information may also include current versions of software and/or firmware residing on the VSMs 38 and a history of previous versions and updates. As understood by one of ordinary skill in the art, and as used herein, “soft parts” may collectively refer to any component or content (e.g., code and/or instructions, etc.) associated with the software, firmware, and/or calibration files for the VSMs 38.

Using the configuration information received from the vehicle 12, the DM server 90 is configured to query the soft parts management module 86 for a “TO BE” state of the VSMs 38 to determine a desired configuration for each VSM. The desired configuration represents a comparison between the current configuration and the latest, most up-to-date configuration of the VSMs 38, which in one embodiment is managed by the soft parts management module 86. The soft parts management module 86 may be communicatively coupled with the soft parts repository 88, and may include applications (e.g., programming instructions) configured to create, manage, and/or map configuration data for the VSMs. The data relating to the configuration of the VSMs 38 is managed by the soft parts management module 86 and/or the soft parts repository 88 and may include a location at which the soft parts are stored. Based on the desired configuration of the VSMs received from the soft parts management module 86, the DM server 90 generates the parts manifest, which identifies the soft part components needed to bring the current configuration of the VSMs up-to-date. As set forth above, the parts manifest includes download links that specify the location at which the soft parts are stored and can be accessed for download to the vehicle 12. In one embodiment, the parts manifest is transmitted from the DM server 90 to the DL server 92, which serves as a download interface between the vehicle 12 and the remote facility 20, but more specifically, the OTA server 82.

The soft parts repository 88 is communicatively coupled to, and in one embodiment, serves as an interface between the soft parts management module 86 and the content delivery network 100. The soft parts repository 88 may be configured to receive, compile, store, and/or mange soft part updates relating to the VSMs. The soft parts repository 88 is further configured to transmit the soft parts to the content delivery network 100, and in particular, to the content delivery server 18, which subsequently publishes the soft parts to various content delivery nodes 102. In one non-limiting embodiment, soft parts repository 88 includes hardware and/or software for managing a database (not shown) that contains records of VSM configuration information. For example, the database may include a relational database having information such as, vehicle makes and models, vehicle system modules for the makes and models, individual vehicle identification numbers (VIN) and other vehicle identifiers, vehicle system software and/or firmware updates including vehicle system parameters and executable code, and trigger event data specifying conditions for employing the configuration updates. The trigger is, for example, a number of ignition cycles, a specific time and date, an expired time, a number of kilometers, a request for a vehicle software update, to name but a few.

### Method—

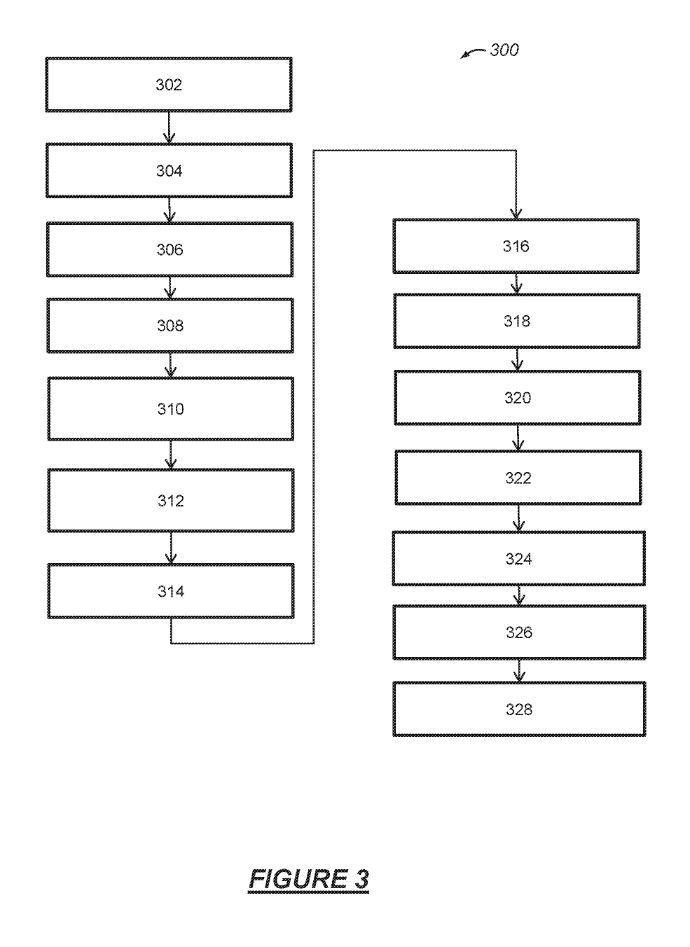

Turning now to FIG. 3, there is shown a method 300 for updating the configuration of vehicle system modules (VSMs) using the system described above with respect to FIGS. 1 and 2. It should be understood that the steps of the method 300 are not necessarily presented in any particular order and that performance of some or all the steps in an alternative order is possible and is contemplated. The method 300 begins at 302 by receiving at the parts repository 88 configuration updates relating to one or more of the VSMs 38. The configuration updates include, without limitation, soft parts that may refer to any content (e.g., code and/or instructions, etc.) associated with the software, firmware, and/or calibration files for the VSMs 38. The configuration updates may be initiated by any means known in the art, including, but not limited to trigger events, consumer requests to check for updates, feature improvements, and recall notifications. At step 304, the configuration updates are transmitted to the content delivery network 100 and published to one or more content delivery nodes 102.

At step 306, the OTA server 82 queries the vehicle 12 for an “AS IS” state of the VSMs 38 to determine a current configuration of the VSMs 38. More specifically, in one implementation, the OTA server 82 query is made from the DM server 90 to the CGM 27 in vehicle 12. In response, at step 308 the vehicle 12 transmits to the OTA server 82 configuration information relating to the current state of the VSMs 38. Based on the current configuration information received at step 308, the OTA server 82 requests at step 310 a “TO BE” state for this particular vehicle 12 from the soft parts management module 86 to determine a desired configuration for each VSM 38. The desired configuration represents a comparison between the current configuration of the VSMs 38 and the latest, most up-to-date configuration. At step 312, the “TO BE” state detailing the desired VSM configuration for the vehicle 12 is transmitted from the soft parts management module 86 to the OTA server 82.

At step 314, the OTA server 82 generates a soft parts manifest, which identifies the soft part components needed to bring the current configuration of the VSMs 38 up-to-date. In one embodiment, the parts manifest is generated by the DM server 90 and includes download links that specify the location at which the soft parts are stored and can be accessed for download to the vehicle 12. In one embodiment, the download link is a URL, the format and function of which is known and understood by those having ordinary skill in the art. In other embodiments the download links can take a different form, such as individual identifiers for each of the different soft parts that the vehicle can then use to locate the soft parts at one or more remote servers, with the location of the different soft parts either being determined by the vehicle itself using the identifiers or being determined remotely by sending the identifiers from the vehicle to the remote location for use in providing a URL or other locator back to the vehicle. In one particular embodiment, the soft parts are stored by the content delivery network 100 and, as described below, accessed by the vehicle via the download links. The parts manifest created by the DM server 90 in step 314 is transmitted at step 316 to the DL server 92.

At step 318, the OTA server 82 sends to the vehicle 12 a request to transmit (e.g., download) the parts manifest. In response to the vehicle granting the request, at step 320 the parts manifest is transmitted from the DL server 92 to the vehicle 12, and more specifically, in one embodiment, to the CGM 27.

At step 322, the vehicle 12 retrieves (e.g., downloads) the soft parts content relating to one or more of the configuration updates using the download links in the parts manifest. In some instances, the vehicle occupant consents to the update using a vehicle user interface prior to downloading the content. In one embodiment, the soft parts content is downloaded from the content delivery network, but more particularly, from a nearest content delivery node 102, which may be determined by the GPS module 36 using known techniques. In this way, the vehicle 12 (through, for example, any suitable vehicle component such as telematics unit 24, infotainment unit 26, and/or CGM 27) may optimize the file downloads to minimize the time and/or cost associated with transferring the content. For example, the vehicle 12 may be configured to schedule or otherwise arrange for content-intensive downloads (i.e., large files) to be transmitted through a vehicle wireless access point (e.g., 50), while smaller, less content-intensive downloads may be transmitted over a vehicle cellular connection (e.g., 42) using wireless carrier system 14.

At step 324, the vehicle 12 assembles the soft part components retrieved at step 322 into a configuration update package. In one embodiment, the update package is assembled according to instructions provided in the soft parts manifest, contained in the downloaded content files, and/or received from the OTA server 82. After assembly of the update package in step 324, the completed update package at step 326 is installed on, or otherwise transmitted to for installation thereon, the VSMs 38. In one example, the installation of the update package is managed and executed by CGM 27. In some instances, the vehicle occupant consents to the update using a vehicle user interface prior to installing the update package.

Upon verification and completion of the update package installation to the VSMs 38 according to known techniques, at step 328 an indication in the form of a message or other suitable communication is sent from the vehicle 12 to the OTA server 82 confirming the successful installation of the configuration update to VSMs 38.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method for providing an update to vehicle system modules, the method comprising the steps of:
generating a parts manifest identifying soft parts associated with an update for the vehicle system modules, the parts manifest including one or more download link(s) relating to the soft parts in the parts manifest, and wherein the one or more download link(s) provide a location from which content associated with each of the soft parts is downloaded to a vehicle and assembled by the vehicle into an update package;
transmitting the parts manifest to the vehicle; and
receiving an indication from the vehicle confirming installation of the update package to the vehicle system modules.

2. The method of claim 1, further including the step of transmitting a query to the vehicle requesting an existing configuration state of the vehicle system modules.

3. The method of claim 1, further including determining a desired configuration state of the vehicle system modules.

4. The method of claim 3, wherein the desired configuration state of the vehicle system modules is determined based on information obtained from a soft parts management module.

5. The method of claim 1, wherein the one or more download link(s) include a uniform resource locator (URL).

6. The method of claim 1, wherein the parts manifest includes instructions for downloading the content of the soft parts to the vehicle from a content delivery network.

7. The method of claim 1, wherein the parts manifest includes instructions for assembling the downloaded content of the soft parts into the update package.

8. The method of claim 1, further comprising the step of transmitting soft part contents relating vehicle system module updates to a content delivery network.

9. A method for providing an update to vehicle system modules, the method comprising the steps of:
receiving a parts manifest identifying soft parts associated with an update for the vehicle system modules, the parts manifest including one or more download link(s) associated with each of the soft parts in the parts manifest;
retrieving content associated with each of the soft parts using a location of the content provided by the one or more download link(s);
assembling the content for each of the soft parts into an update package; and
providing the update package to the vehicle system modules.

10. The method of claim 9, further including the step of receiving a query requesting an existing configuration state of the vehicle system modules.

11. The method of claim 9, wherein the one or more download link(s) include a uniform resource locator (URL).

12. The method of claim 9, wherein the parts manifest includes instructions for downloading the content of the soft parts to the vehicle from a content delivery network.

13. The method of claim 9, wherein the parts manifest includes instructions for assembling the downloaded content of the soft parts into the update package.

14. A system for providing an update to vehicle system modules, the system comprising:
a server communicatively coupled to a vehicle communication system, the server configured to:
generate a parts manifest identifying soft parts associated with an update for the vehicle system modules, the parts manifest including one or more download link(s) relating to the soft parts in the parts manifest, and wherein the one or more download link(s) provide a location from which content associated with each of the soft parts is downloaded to a vehicle and assembled by the vehicle into an update package;
transmit the parts manifest to the vehicle; and
receive an indication from the vehicle confirming installation of the update package to the vehicle system modules.

15. The system of claim 14, wherein the server is further configured to query to the vehicle requesting an existing configuration state of the vehicle system modules, and to determine a desired configuration state of the vehicle system modules.

16. The system of claim 14, wherein the parts manifest includes instructions for downloading the content of the soft parts to the vehicle from a content delivery network and for assembling the downloaded content of the soft parts into the update package.

17. The system of claim 14, wherein the server is an over-the-air server configured to include a device management (DM) server for generating the parts manifest and a download (DL) server for transmitting the parts manifest to the vehicle.

18. A system for providing an update to vehicle system modules, the system comprising:
at least one vehicle system module communicatively coupled to a remote facility, the at least one vehicle system module configured to:
receive a parts manifest identifying soft parts associated with an update for the vehicle system modules, the parts manifest including one or more download link(s) associated with each of the soft parts in the parts manifest;
retrieve content associated with each of the soft parts using a location of the content provided by the one or more download link(s);
assemble the content for each of the soft parts into an update package; and
provide the update package to the vehicle system modules.

19. The system of claim 18, wherein the parts manifest includes instructions for downloading the content of the soft parts to the vehicle from a content delivery network and for assembling the downloaded content of the soft parts into the update package.

20. The system of claim 18, wherein the at least one vehicle system module is a centralized gateway module.
